(19) United States
(12) Patent Application Publication
(10) Pub. No.: US 2011/0184953 A1
(43) Pub. Date: Jul. 28, 2011

(54) ON-LOCATION RECOMMENDATION FOR PHOTO COMPOSITION

(76) Inventors: Dhiraj Joshi, Rochester, NY (US); Jiebo Luo, Pittsford, NY (US); Jie Yu, Rochester, NY (US); Jeffrey C. Snyder, Fairport, NY (US)

(21) Appl. No.: 12/693,621

(22) Filed: Jan. 26, 2010

(51) Int. Cl. G06F 17/30

(52) U.S. Cl. 707/738; 707/E17.02

(57) ABSTRACT

A method of providing at least one recommended view to a user at a current geographic location that the user can use in composing images, comprising using a processor to provide the following steps using the geographic location of the user to obtain, from a database, images that were previously taken around the current geographic location; grouping the obtained images into clusters that correspond to distinct scenes; selecting a recommended view for each distinct scene using an image; and presenting the recommended view(s) to the user for consideration in composing images.

### FIELD OF THE INVENTION

The present invention relates to providing a method for selecting recommended views as pictures around a current geographic location of a user.

### BACKGROUND OF THE INVENTION

Geographical positioning systems (GPS) devices have revolutionized the art and science of tourism. Besides providing navigational services, GPS units store information about recreational places, parks, restaurants, and airports that are useful to make travel decisions on the fly. Popularity of the GPS technology is an ideal example of how our daily lives have become tied to the need for instant location specific information. From being a standalone navigational device in the past, today's GPS has found its way into mobile devices and cameras with inbuilt or attached receivers.

A fast-emerging trend in digital photography and community photo sharing is geo-tagging. The phenomenon of geo-tagging has generated a wave of geo-awareness in multimedia. Flickr amasses about 3.2 million photos geo-taggedper month. Geo-tagging is the process of adding geographical identification metadata to various media such as websites or images and is a form of geospatial metadata. It can help users find a wide variety of location-specific information. For example, one can find images taken near a given location by entering latitude and longitude coordinates into a geo-tagging enabled image search engine. Geo-tagging-enabled information services can also potentially be used to find location-based news, websites, or other resources. Capture of geo-coordinates or availability of geographically relevant tags with pictures opens up new data mining possibilities for better recognition, classification, and retrieval of images in personal collections and the Web. Lyndon Kennedy et al “How Flickr Helps us Make Sense of the World: Context and Content in Community-Contributed Media Collections”, Proceedings of ACM Multimedia 2007 discusses how geographic context can be used for better image understanding.

U.S. Pat. No. 7,616,248 describes a camera and method by which a scene is captured as an archival image, with the camera set in an initial capture configuration. Then, pluralities of parameters of the scene are evaluated. The parameters are matched to one or more of a plurality of suggested capture configurations to define a suggestion set. User input designating one of the suggested capture configurations of the suggestion set is accepted and the camera is set to the corresponding capture configuration. The aforementioned patent describes a suggestion camera for enhanced picture taking. With the ever growing amount of geo-tagged image data on the Web, employing geographic information about images in addition to image pixel information for real-time suggestion for picture composition is expected to be very beneficial.

U.S. Patent Application Publication No. 2007/0271297 describes an apparatus and method for summarizing (or selecting a representative subset from) a collection of media objects. A method includes selecting a subset of media objects from a collection of geographically-referenced (e.g., via GPS coordinates) media objects based on a pattern of the media objects within a spatial region. The media objects can further be selected based on (or be biased by) various social aspects, temporal aspects, spatial aspects, or combinations thereof relating to the media objects or a user. Another method includes clustering a collection of media objects in a cluster structure having a plurality of subclusters, ranking the media objects of the plurality of subclusters, and selection logic for selecting a subset of the media objects based on the ranking of the media objects. While the aforementioned patent publication describes summarization of a collection of geo-referenced pictures to form subsets, there is a need to apply summarization to discover views around a current geographic location of a user for real-time recommendation.

### SUMMARY OF THE INVENTION

In accordance with the present invention, there is provided a method of providing at least one recommended view to a user at a current geographic location that the user can use in composing images, comprising using a processor to provide the following steps:

(a) using the geographic location of the user to obtain, from a database, images that were previously taken around the current geographic location;

(b) grouping the obtained images into clusters that correspond to distinct scenes;

(c) selecting a recommended view for each distinct scene using an image; and

(d) presenting the recommended view(s) to the user for consideration in composing images.

Features and advantages of the present invention include providing guidance to tourists who look for opportunities for taking pictures in and around a point of interest.

### BRIEF DESCRIPTION OF THE DRAWINGS

FIG. 1 is a pictorial representation of a system that will be used to practice an embodiment of the current invention;

FIG. 2 is a pictorial representation of a processor;

FIG. 3 is a flowchart showing steps required for practicing an embodiment of the current invention;

FIG. 4 is a flowchart showing steps required for practicing an embodiment of visual feature extraction, meta-data feature extraction, and image clustering;

FIG. 5 is a flowchart showing steps required for practicing an embodiment of recommended views selection from image features, image clusters, or user input;

FIGS. 6a and 6b show by illustration two methods for computing visual representativeness of images in clusters; and

FIGS. 7a-7d show by illustration examples of recommended views based on four different criteria.

### DETAILED DESCRIPTION OF THE INVENTION

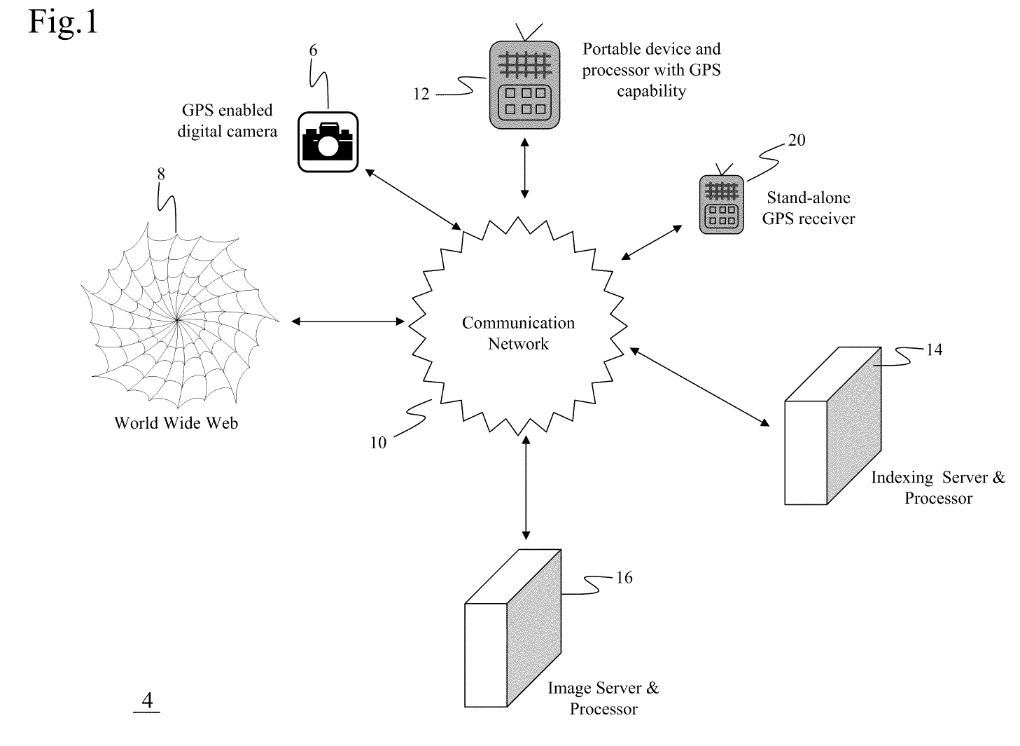

The invention provides at least one recommended view to a user at a current geographic location that the user can use in composing images. The current geographic location of the user can be in the form of latitude-longitude pair or in the form of street address. The current geographic location can be obtained from a hand-held GPS enabled camera or a portable processor (devices 6 and 12 in FIG. 1) or from a stand-alone GPS receiver (device 20 in FIG. 1).

Views can be recommended based on user preferences or by using a plurality of criteria including types of scenes, presence or absence of people, children, or couples, poses with landmarks, or photogenic values of images. Such recommended views can be discovered from large Web image repositories in the form of pictures taken previously by other people who visited the place in the past. Recommended views can assist a user in composing their photographs. Moreover, it is especially important to provide for a plurality of criteria for discovering such recommended views. When there are many photographic opportunities around a point of interest, suggestions for scenic spots or views are usually obtained from a tourist visitor center or by looking at visitor guide books. The current invention provides a method for making such suggestions automatically by analyzing public domain photographs taken around the current location.

In the current invention, recommended view(s) can be considered by a user to compose photographs. Some examples of recommendations include typical couple shots, suggesting composition for children's pictures, group shots, or poses with certain landmarks. This can be achieved by analyzing the visual and meta-data content of images taken previously around the current location.

In FIG. 1, a system 4 is shown with the elements required to practice the current invention including a GPS enabled digital camera 6, a portable computing device and processor 12, an indexing server and processor 14, an image server and processor 16, a communications network 10, and the World Wide Web 8. Portable computing device and processor can be a smart-phone, a trip advisor, or a GPS navigation device. It is assumed that portable computing device and processor is capable of computations as are most standard handheld devices and also capable of transferring and storing images, text, and maps and displaying these for the users. GPS enabled digital camera 6 and portable computing device and processor 12 have GPS capability. GPS information in GPS enabled digital camera 6 and portable computing device and processor 12 can be obtained from inbuilt GPS receivers, standalone GPS receivers (device 20), or from cell-towers.

In the current invention, images will be understood to include both still and moving or video images. It is also understood that images used in the current invention have GPS information. Portable computing device and processor can communicate through communications network 10 with the indexing server and processor 14, the image server and processor 16, and the World Wide Web 8. Portable computing device and processor is capable of requesting updated information from indexing server and processor 14 and image server and processor 16.

Indexing server and processor 14 is a computing device and processor available on communications network 10 for the purpose of executing the algorithms in the form of computer instructions. Indexing server and processor 14 is capable of executing algorithms that analyze the content of images for semantic information including scene category types, detection of people, age and gender classification, and photogenic value computation. Indexing server and processor 14 also stores results of algorithms executed in flat files or in a database. Indexing server and processor 14 periodically receives updates from image server and processor 16 and if required performs re-computation and re-indexing. It will be understood that providing this functionality in system 10 as a web service via indexing server and processor 14 is not a limitation of the invention.

Image server and processor 16 is a computing device and processor that communicates with the World Wide Web and other computing devices via the communications network 10 and upon request, provides image(s) photographed in the provided position to portable computing device and processor for the purpose of display. Images stored on image server and processor 16 are acquired in a variety of ways. Image server and processor 16 is capable of running algorithms as computer instructions to acquire images and their associated meta-data from the World Wide Web through the communication network 10. GPS enabled digital camera devices 6 can also transfer images and associated meta-data to image server and processor 16 via the communication network 10.

Images from a plurality of geographic regions from all over the world will be used for practicing an embodiment of the current invention. These images can represent many different scene categories and can have diverse photogenic values. Images used in a preferred embodiment of the current invention will be obtained from certain selected image sharing Websites (for example Yahoo! Flickr) that permit storing of geographical meta-data with images and provide automated programs to request for images and associated meta-data. Images can also be communicated via GPS enabled cameras 6 (FIG. 1) to image server and processor 16 (FIG. 1). Quality control issues can arise when permitting individual people to upload their personal pictures in image server. However the current invention does not address this issue and it is assumed that only bona-fide users have access to the image server and direct user uploads are trustworthy.

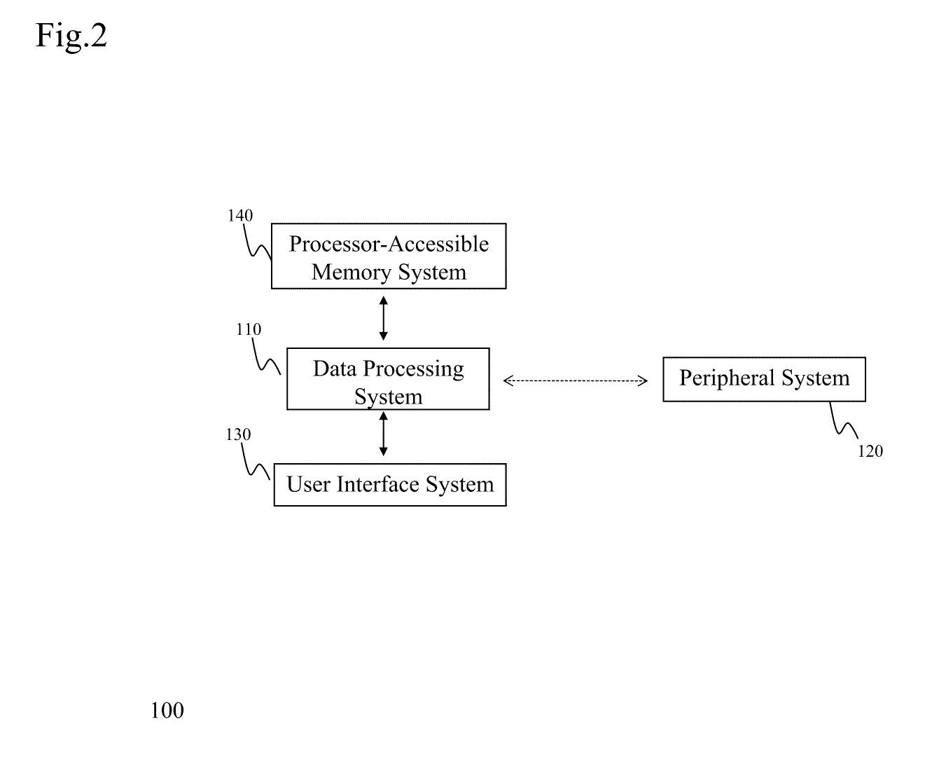

FIG. 2 illustrates a processor 100 and its components. In an embodiment of the current invention portable computing device and processor 12, indexing server and processor 14, and image server and processor 16 of FIG. 1 have one or a plurality of processors with the described components. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

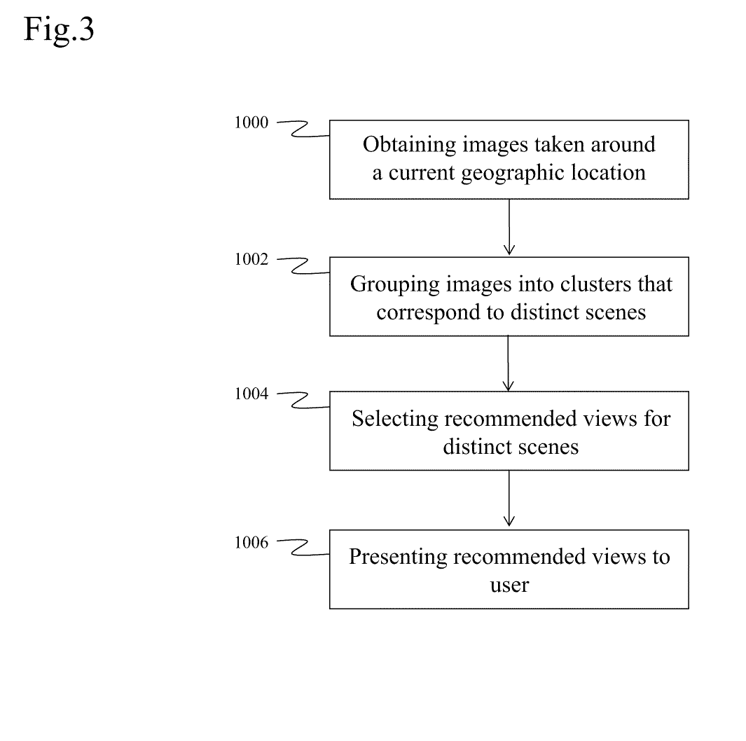

The data processing system 110 includes one or more data processing devices that implement the processes of the various embodiments of the present invention (see FIG. 3). The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device or component thereof for processing data, managing data, or handling data, whether implemented with electrical, magnetic, optical, biological components, or otherwise.

The processor-accessible memory system 140 includes one or more processor-accessible memories configured to store information, including the information needed to execute the processes of the various embodiments of the present invention. The processor-accessible memory system 140 can be a distributed processor-accessible memory system including multiple processor-accessible memories communicatively connected to the data processing system 110 via a plurality of computers or devices. On the other hand, the processor-accessible memory system 140 need not be a distributed processor-accessible memory system and, consequently, can include one or more processor-accessible memories located within a single data processor or device. The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110. The peripheral system 120 can include one or more devices configured to provide digital images to the data processing system 110. For example, the peripheral system 120 can include digital video cameras, cellular phones, regular digital cameras, or other data processors. The data processing system 110, upon receipt of digital content records from a device in the peripheral system 120, can store such digital content records in the processor-accessible memory system 140. The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130.

The user interface system 130 can also include a display device, a processor-accessible memory, or any device or combination of devices to which data is output by the data processing system 110. In this regard, if the user interface system 130 includes a processor-accessible memory, such memory can be part of the processor-accessible memory system 140 even though the user interface system 130 and the processor-accessible memory system 140 are shown separately in FIG. 2.

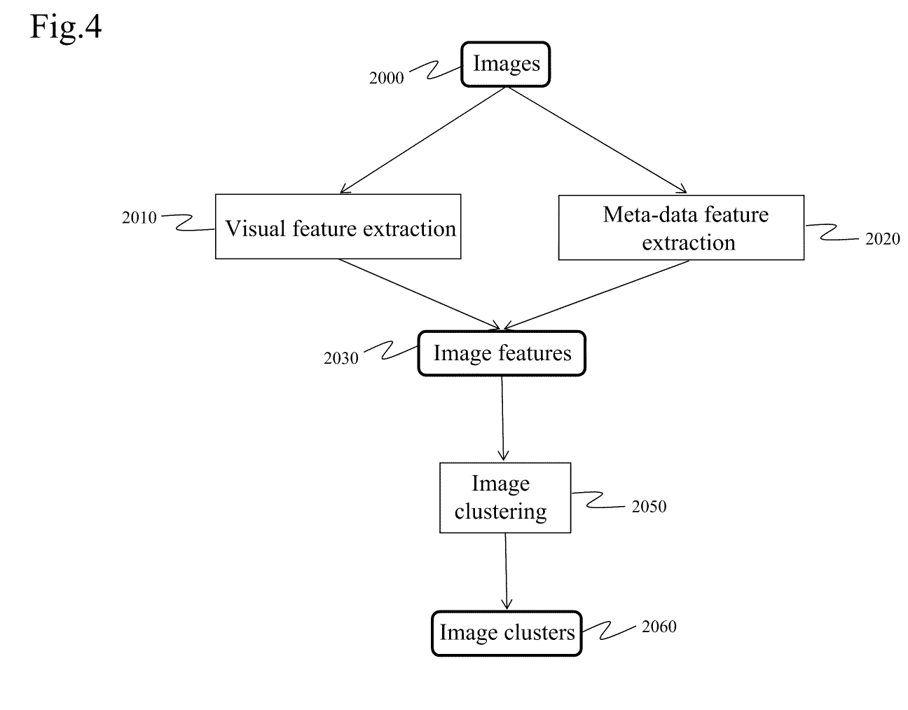

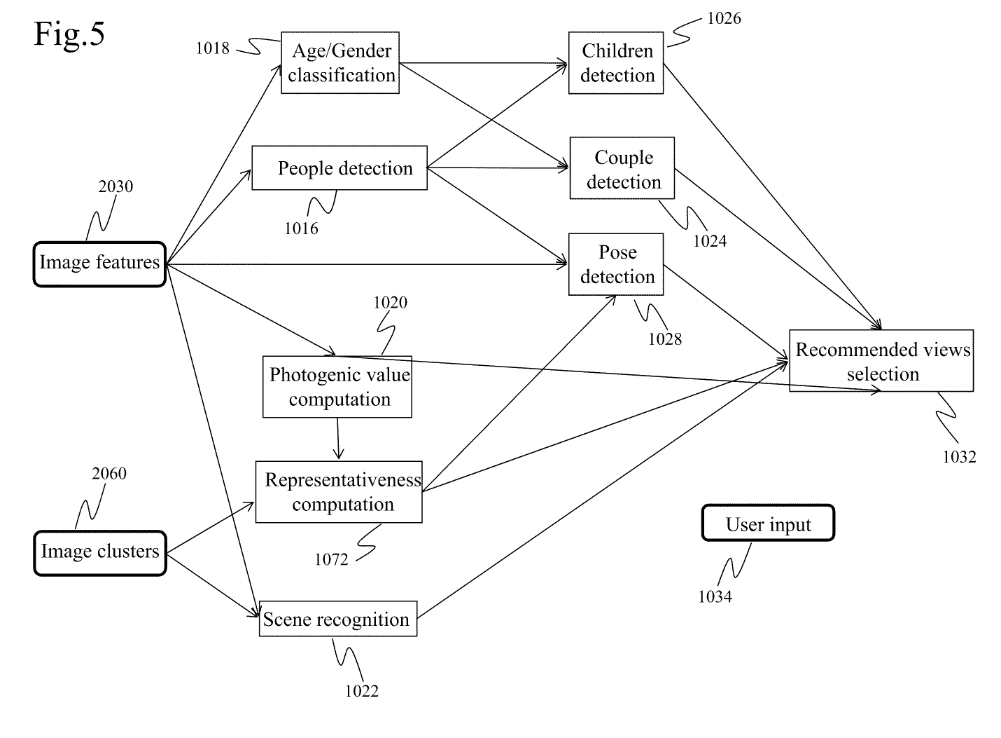

FIG. 3 shows the main steps involved in the current invention. In step 1000 images taken around the current geographic location of the user are obtained from the image server and processor 16 (FIG. 1). The current geographic location of the user can be in the form of latitude-longitude pair or in the form of street address. The current geographic location can be obtained from the hand-held GPS enabled camera 6 or the portable computing device and processor 12 (FIG. 1) or from a stand-alone GPS receiver 20 (FIG. 1). In an embodiment of the current invention, images taken within a radius of 300 m of the current location are obtained in step 1000. This radius can also be adaptively chosen based on the density of pictures around the current location. The radius can be small for heavily photographed regions and large for sparsely photographed regions. Step 1002 performs clustering of images where distinct image clusters represent distinct scenes in and around the current location of the user. Hence clusters or groups correspond to distinct scenes. In step 1004, a recommended view is selected for each distinct scene from among images in the corresponding cluster using a plurality of criteria. The recommended views are selected in the form of pictures taken previously by other people who visited the place. The recommended views are presented to the user in step 1006 who can then consider the recommended views in composing photographs. Steps 1000 and 1002 are further elaborated in FIG. 4 while step 1004 is described in detail in FIG. 5.

In FIG. 4, images 2000 pass through visual feature extraction (2010) and meta-data feature extraction (2020) steps. The visual features and meta-data features are used for clustering images (step 2050) into a number of groups for further processing. The number of groups can be predefined or adaptively chosen by the clustering algorithm. The feature extraction steps also involve extraction of a plurality of features that are used for subsequent steps as shown in FIG. 5. Visual features are a plurality of numeric or categorical values calculated from the image pixel data. Meta-data features are a plurality of numeric or categorical values calculated from sources other than image pixel data including image tags, GPS, time stamp, date and other information available with images. Image features are defined as any combination of meta-data and visual features, including meta-data features alone, visual features alone, or both meta-data and visual features.

Recently, many people have shown the efficacy of representing the visual feature of images as an unordered set of image patches or “bag of visual words” (as in the published articles of F.-F. Li and P. Perona, A Bayesian hierarchical model for learning natural scene categories, Proceedings of CVPR, 2005; S. Lazebnik, C. Schmid, and J. Ponce, Beyond bags of features: spatial pyramid matching for recognizing natural scene categories, Proceedings of CVPR, 2006). A preferred embodiment of the current invention uses the bag of visual words as visual feature of an image. Suitable descriptions (e.g., so called SIFT descriptors) are computed for images, which are further clustered into bins to construct a “visual vocabulary” composed of “visual words”. The intention is to cluster the SIFT descriptors into “visual words” and then represent an image in terms of their occurrence frequencies in it. The well-known k-means algorithm is used with cosine distance measure for clustering these descriptors. While this representation throws away the information about the spatial arrangement of these patches, the performances of systems using this type of representation on classification or recognition tasks are impressive. In particular, an image is partitioned by a fixed grid and represented as an unordered set of image patches. Suitable descriptions are computed for such image patches and clustered into bins to form a “visual vocabulary”. The same methodology has been extended to consider both color and texture features for characterizing each image grid. An image grid is further partitioned into 2×2 equal size sub-grids. Then for each subgrid, one can extract the mean R, G and B values to form a 4×3=12 feature vector which characterizes the color information of 4 sub-grids. To extract texture features, one can apply a 2×2 array of histograms with 8 orientation bins in each sub-grid. Thus a 4×8=32-dimensional SIFT descriptor is applied to characterize the structure within each image grid, similar in spirit to Lazebnik et al. In a preferred embodiment of the present invention, if an image is larger than 200,000 pixels, it is first resized to 200,000 pixels. The image grid size is then set to 16×16 with overlapping sampling interval 8×8. Typically, one image generates 117 such grids.

After extracting all the raw image features from image grids, separate color and texture vocabularies are constructed by clustering all the image grids in the dataset through k-means clustering. In a preferred embodiment of the current invention, both vocabularies are set to size 500. By accumulating all the grids in the set of images, one obtains two normalized histograms for an event, hc and ht, corresponding to the word distribution of color and texture vocabularies, respectively. Concatenating hc and ht, the result is a normalized word histogram of size 1000. Each bin in the histogram indicates the occurrence frequency of the corresponding word.

Clustering of images can be performed using a plurality of methods. A method for clustering images has been described in the published article of Y. Chen, J. Z. Wang, and R. Krovetz, Clue: Cluster-based retrieval of images by unsupervised learning, IEEE Transactions on Image Processing, 2005. Methods for clustering media with GPS information are also described in U.S. Patent Application Publication No. 2007/0271297. Any of a plurality of clustering methods can be used for the current invention. The clustering methods referenced above are for example only and should not be construed to limit the invention.

Image features 2030 and image clusters 2060 in FIG. 4 are used for subsequent steps for selecting recommended views as discussed in FIG. 5. Recommended views can be discovered using a plurality of criteria including types of scenes, presence or absence of people, children, or couples, poses with landmarks, or photogenic values of images. User input can help to choose from the aforementioned criteria. Recommended views are discovered from large Web image repositories in the form of pictures taken previously by other people who visited the place in the past.

FIG. 5 shows the sequence of steps required to select recommended views using image features (2030), image clusters (2060), and a user input (1034). Recommended views selection (1032) can be performed by one or more combination of the steps including age/gender classification (1018), people detection (1016), photogenic value computation (1020), representativeness computation (1072), scene recognition (1022), children detection (1026), couple detection (1024), or pose detection (1028). In an embodiment of the current invention, the user input (1034) provides user's selection of one or multiple choices from a plurality of criteria, including types of scenes, presence or absence of people, children, or couples, or poses with landmarks.

In the current invention, each cluster represents a distinct scene and step 1022 recognizes the scene types represented in image clusters. In computer vision, scene recognition has been studied as a classification problem. The published article of S. Lazebnik, C. Schmid, and J. Ponce, Beyond Bags of Features: Spatial Pyramid Matching for Recognizing Natural Scene Categories, In Proceedings of Int. Conference on Computer Vision and Pattern Recognition, 2006 describes a method for scene recognition using SIFT descriptors. In an embodiment of the invention, scene categories recognized in step 1022 include “cities”, “historical sites”, “sports venues”, “mountains”, “beaches/oceans”, “parks”, or “local cuisine”. However using the aforementioned categories is not a limitation of the current invention. Moreover, scene category of an image can be collectively determined by all images in the cluster to which it belongs. In an embodiment of the current invention, scene categories are first assigned to individual images in a cluster. The assignments are then refined based on the most predominant scene category of images in the clusters. Group scene category assignments are expected to be more reliable than individual assignments and are less affected by errors due to incorrectly labeled images.

People detection (step 1016) detects the presence or absence of one or more human beings in pictures. This can serve as a criterion for recommended views computation for people who are looking for location and views for group spots. Detection of people in pictures has been performed in the published article of N. Dalal and B. Triggs, Histogram of Oriented Gradients for Human Detection, Proceedings of International Conference on Computer Vision, 2005. People detection can also be done by using meta-data features alone. In an embodiment of the current invention, step 1016 compares image tags with a list of popular first and last names in the US to determine if people are present in the picture.

Step 1018 determines ages and genders of people in pictures. Facial age classifiers are well known in the field, for example, A. Lanitis, C. Taylor, and T. Cootes, “Toward automatic simulation of aging effects on face images,” PAMI, 2002, and X. Geng, Z. H. Zhou, Y. Zhang, G. Li, and H. Dai, “Learning from facial aging patterns for automatic age estimation,” in proceedings of ACM Multimedia, 2006, and A. Gallagher in U.S. Patent Application Publication No. 2006/0045352. Gender can also be estimated from a facial image, as described in M. H. Yang and B. Moghaddam, “Support vector machines for visual gender classification,” in Proceedings of ICPR, 2000, and S. Baluja and H. Rowley, “Boosting sex identification performance,” in International Journal of Computer Vision, 2007. Determining ages and genders of people in pictures can be used to identify children in pictures (step 1026) to recommend views especially designed for children (for example, children posing with Mickey Mouse or Santa Claus). Another useful recommended view follows detection of a couple to suggest spots where couples usually take pictures (step 1024). This can be achieved by first detecting the presence of a man and a woman (using people detection and age-gender classification in steps 1016 and 1018) followed by computing the distance between them in the picture. Typically couples sit or stand close to each other. U.S. Patent Application Publication No. 2009/0192967 describes methods to discover social relationships from personal photo collections. An embodiment of the current invention analyses the personal collections of volunteers to learn the relationship between geometrical arrangement of faces in couple-shots and their distance from the camera. This is further used in step 1024 to determine the presence of couples in pictures.

Step 1020 in FIG. 5 computes photogenic values of images. Photogenic value is a numeric measure of how aesthetically beautiful a picture looks or a measure of the pleasantness of emotions that the picture arouses in people. A picture with a higher photogenic value is expected to look more beautiful and pleasing than a picture with low photogenic value. Researchers in computer vision have attempted to model aesthetic value or quality of pictures based on their visual content. An example of such a research is found in the published article of R. Datta, D. Joshi, J. Li, and J. Z. Wang, Studying Aesthetics in Photographic Images Using a Computational Approach, Proceedings of European Conference on Computer Vision, 2006. The approach presented in the aforementioned article classifies pictures into aesthetically high and aesthetically low classes based on color, texture, and shape based features which are extracted from the image. In the approach presented in the previous article, training images are identified for each of the “aesthetically high” and “aesthetically low” categories and a classifier is trained. At classification time, the classifier extracts color, texture, and shape based features from an image and classifies it into “aesthetically high” or “aesthetically low” class. The aforementioned article also presents aesthetics assignment as a linear regression problem where images are assigned a plurality of numeric aesthetic values instead of “aesthetically high and low” classes. Support vector machines have been widely used for regression. The published article of A. J. Smola and B. Schölkopf, A tutorial on support vector regression, Statistics and Computing, 2004 describes support vector regression in detail. An embodiment of the current invention uses image features as proposed in the published article of R. Datta, D. Joshi, J. Li, and J. Z. Wang, Studying Aesthetics in Photographic Images Using a Computational Approach, Proceedings of European Conference on Computer Vision, 2006. Additionally, a support vector regression technique to assign photogenic values from among a plurality of values in the range 1 to 10 is used (a more photogenic picture receives a higher value than a less photogenic picture). Fixing the range of photogenic values to “1 to 10” is not a limitation of the current invention.

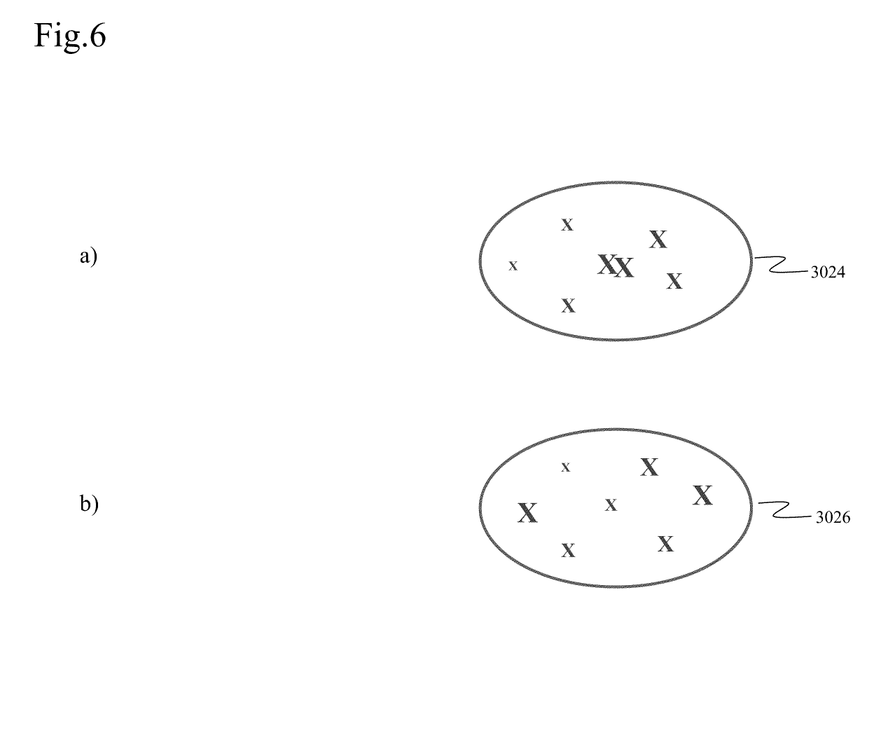

In the absence of a user given criteria for determining recommended views, visual representativeness can be used as an appropriate criterion. Visual representativeness is a numeric value or rank assigned to images in a cluster purely based on their image features. Images with high representativeness values are expected to visually summarize their cluster. In the current invention, representativeness of images in their respective clusters is computed in step 1072 in FIG. 5. Step 1072 also involves determining the most representative picture in each cluster. FIGS. 6a and 6b show two methods (3024 and 3026) for computing representativeness in clusters. In the figure, crosses correspond to images for illustration. The surrounding ellipses correspond to clusters. The sizes of crosses correspond to the representativeness of images in the clusters. A cluster centroid is defined as the point that is closest to the geometric center of the cluster. The method 3024 computes distances of images from their cluster centroids and then computes representativeness as a decreasing function of this distance. In a particular embodiment of the current invention, the distance used can be Euclidean distance between images and their respective cluster centroids while the decreasing function for computing representativeness can be the inverse of the distance. Photogenic values of images computed in step 1020 in FIG. 5 can also directly be used as their representativeness. The two methods for representativeness 3024 (Distance from the centroid) and 3026 (Photogenic value) can be adopted in two embodiments of the current invention.

Another important criterion for recommending views is detection of poses that people like to make in their pictures especially with certain landmarks such as the Taj Mahal or the leaning tower of Pisa that look unrealistic (such as appearing to hold the Taj Mahal or appearing to support the leaning tower of Pisa) and make the picture memorable. The current invention uses the assumption that poses with landmarks automatically stand-out as their cluster representatives. In an embodiment of the current invention pose (step 1028) detection involves two steps:

1. People detection (step 1016).

2. Representativeness computation (step 1072).

Computer vision methods have been proposed for pose detection in video. The published article of D. Ramanan, D. Forsyth, and A. Zisserman, Strike a pose: Tracking people by finding stylized poses, International Conference on Computer Vision, 2005 describes one such method. Another embodiment of the current invention uses poses learned from video to detect poses in images.

In yet another embodiment, human subjects provide pose related ground-truth information for images with certain selected landmarks and visual classifiers based on support vector machines (SVMs) are trained to recognize poses.

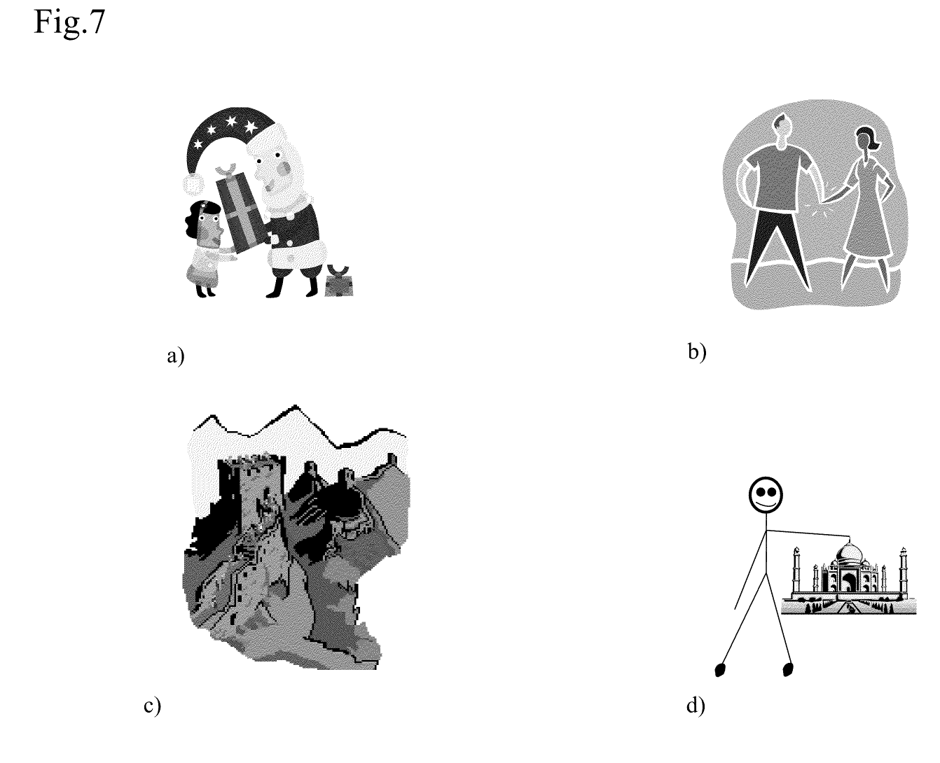

For each distinct cluster, steps 1022 (scene recognition), 1026 (children detection), 1024 (couple detection), or 1028 (pose detection) can provide a plurality of pictures as candidates for recommendation. In one embodiment of the current invention, images with the largest representativeness values, computed at step 1072, are selected as the recommended views for each cluster. FIGS. 7a-7d show four examples, by illustration, of recommended views including (a) Santa with a child, (b) A couple posing for a picture, (c) A representative picture of Great Wall of China, and (d) A pose of a person appearing to hold the Taj Mahal.

The various embodiments described above are provided by way of illustration only and should not be construed to limit the invention. Those skilled in the art will readily recognize various modifications and changes that can be made to the present invention without following the example embodiments and applications illustrated and described herein, and without departing from the true spirit and scope of the present invention, which is set forth in the following claims.

### PARTS LIST

4 system
6 GPS enabled digital camera
8 World Wide Web
10 Communication Network
12 Portable computing device and processor
14 Indexing server and processor
16 Image server and processor
20 Stand-alone GPS receiver
34 User input
100 All elements of a processor
110 Data processing system
120 Peripheral system
130 User interface system
140 Processor-accessible memory system
1000 Image obtaining step
1002 Image clustering step
1004 Recommended view(s) selection step
1006 Recommended view(s) presentation step
1016 People detection step
1018 Age/Gender classification step
1020 Photogenic value computation step
1022 Scene recognition step
1024 Couple detection step
1026 Children detection step
1028 Pose detection step
1032 Recommended views selection step
1072 Representative computation step
2000 Images required to practice invention
2010 Visual feature extraction step
2020 Meta-data feature extraction step
2030 Image features
2050 Image clustering step
2060 Image clusters
3024 Illustration to show visual representativeness determined by distance from cluster centroid
3026 Illustration to show visual representativeness determined by photogenic value

1. A method of providing at least one recommended view to a user at a current geographic location that the user can use in composing images, comprising using a processor to provide the following steps:
(a) using the geographic location of the user to obtain, from a database, images that were previously taken around the current geographic location;
(b) grouping the obtained images into clusters that correspond to distinct scenes;
(c) selecting a recommended view for each distinct scene using an image; and
(d) presenting the recommended view(s) to the user for consideration in composing images.

2. The method of claim 1 wherein step (c) includes using visual features of images to select the recommended view.

3. The method of claim 2 wherein step (c) further includes using meta-data features of images to select the recommended view.

4. The method of claim 1 wherein step (c) includes taking user input of one or multiple choices from a plurality of criteria, including types of scenes, presence or absence of people, children, or couples, or poses with landmarks to select the recommended view.

5. The method of claim 1 wherein step (c) includes using visual representativeness of images in each distinct scene to select the recommended view.

6. The method of claim 2 wherein step (c) further includes scene recognition in images to select the recommended view.

7. The method of claim 3 wherein step (c) further includes using photogenic values of images to select the recommended view.

8. The method of claim 1 wherein step (c) includes using presence of people in images to select the recommended view.

9. The method of claim 8 wherein presence of people in images is detected using visual features.

10. The method of claim 9 wherein presence of people in images is detected further using image meta-data.

11. The method of claim 8 wherein the number, age, or gender of the people is used to select the recommended view.

12. The method of claim 11 wherein the number, age, or gender of the people is detected using people recognition algorithms.

13. The method of claim 8 wherein the pose of the people is used to select the recommended view.

14. The method of claim 1 wherein the current geographic location is provided by a GPS enabled device.
